(19) United States
(12) Patent Application Publication
(10) Pub. No.: US 2026/0298662 A1
(43) Pub. Date: Oct. 1, 2026

(54) METHOD FOR GENERATING A MAP REPRESENTATION FOR A VEHICLE

(71) Applicant: Robert Bosch GmbH, Stuttgart (DE)

(72) Inventors: Hans-Georg Raumer, Hildesheim (DE); Max Kirstein, Hohenhameln - Ot Bruendeln (DE); Thomas Wenzel, Hamburg (DE); Thorben Funke, Sarstedt (DE)

(21) Appl. No.: 19/629,214

(22) Filed: Mar. 26, 2026

(30) Foreign Application Priority Data
Mar. 31, 2025 (DE) 10 2025 112 439.6

(51) Int. Cl. G01C 21/00; G06V 10/80; G06V 10/82

(52) U.S. Cl. CPC G01C 21/3833; G01C 21/3807; G06V 10/806; G06V 10/82

(57) ABSTRACT

A computer-implemented method for generating a map representation for a vehicle. The method includes: receiving, using an onboard map generation system, environmental sensor data of at least one environmental sensor of the vehicle, wherein the environmental sensor data at least partially depict an environment of the vehicle; receiving map data of an electronic road map using the onboard map generation system, wherein the map data at least partially depict a traffic infrastructure within the environment of the vehicle, and wherein the map data include behavioral information regarding average traffic behavior of road users in relation to the traffic infrastructure within the environment of the vehicle; and generating, using the onboard map generation system, the map representation of the environment of the vehicle based on the environmental sensor data and the behavioral information of the map data, wherein the map representation includes the behavioral information.

### CROSS REFERENCE

The present application claims the benefit under 35 U.S.C. § 119 of Germany Patent Application No. DE 10 2025 112 439.6 filed on March 31, 2025, which is expressly incorporated herein by reference in its entirety.

### FIELD

The present disclosure relates to a method for generating a map representation for a vehicle.

### BACKGROUND INFORMATION

Certain methods for generating maps for vehicles are described in the related at.

It is an object of the present disclosure to provide an improved method for generating a map representation for a vehicle.

### SUMMARY

The object may be achieved by a method including certain features of the present disclosure. Advantageous embodiments are disclosed herein.

According to one aspect, a computer-implemented method for generating a map representation for a vehicle is provided. According to an example embodiment, the method comprises:

receiving, by means of an onboard map generation system, environmental sensor data of at least one environmental sensor of the vehicle, wherein the environmental sensor data at least partially depict an environment of the vehicle;

receiving map data of an electronic road map by means of the onboard map generation system, wherein the map data at least partially depict a traffic infrastructure within the environment of the vehicle, and wherein the map data comprise behavioral information regarding average traffic behavior of road users in relation to the traffic infrastructure within the environment of the vehicle, and wherein the map data comprise behavioral information regarding average behavior of other road users in relation to the traffic infrastructure; and

generating, by means of the onboard map generation system, a map representation of the environment of the vehicle on the basis of the environmental sensor data and the behavioral information of the map data, wherein the map representation comprises the behavioral information.

This can achieve a technical advantage that an improved method for generating a map representation for a vehicle can be provided. The map representation is generated by means of an onboard map generation system on the basis of environmental sensor data of at least one environmental sensor of the vehicle. The map representation is thus created during operation of the vehicle, by means of the onboard map generation system implemented in the vehicle.

In addition to the environmental sensor data, which at least partially depict the environment of the vehicle, map data of an electronic road map are also taken into account for the map creation by means of the onboard map generation system. The electronic road map depicts a traffic infrastructure of the environment of the vehicle and comprises behavioral information.

Behavioral information, within the meaning of the application, is information about the average behavior of road users in the particular region of the traffic infrastructure within the particular environment of the vehicle. The behavior in question can be any behavior related to road traffic. Road users can be any type of road user from the related and prior art.

On the basis of the environmental sensor data, which depict a current state of the environment of the vehicle, and taking into account the map data of the road map which are based on historical data and at least partially depict the traffic infrastructure within the environment of the vehicle, the map representation is subsequently generated by means of the onboard map generation system. The map representation comprises at least the behavioral information of the road map.

The map representation, within the meaning of the application, is a map of the environment of the vehicle that is generated by the onboard map generation system carrying out an onboard map generation (OMG). The map representation represents the current state of the environment of the vehicle and comprises information based on the environmental sensor data of the at least one environmental sensor and is expanded with information from the electronic road map, in particular the behavioral information.

By taking into account the behavioral information from the electronic road map, the method according to the present disclosure can provide an improved map representation of the environment of the vehicle during operation of the vehicle, which map representation is expanded with the behavioral information from the electronic road map.

Here, the electronic road map serves as a map prior, as is conventional for onboard map generation systems.

According to one example embodiment, the behavioral information comprises at least one sub-information item from the following list: average movement path, average movement speed profile, average braking point, average lane change point.

This can achieve a technical advantage that, by means of the corresponding behavioral information, the map representation generated by means of the onboard map generation system can be expanded with relevant information that describes the average behavior of road users. The behavioral information can be associated with corresponding positional information. The behavior can therefore be related to individual positions within the environment of the vehicle and within the traffic infrastructure.

According to one example embodiment, the environmental sensor data comprise image data and/or video data, and/or wherein the method further comprises:

converting the environmental sensor data into bird's-eye-view features by means of a transformer of a BEV backbone of the onboard map generation system;

extracting map features on the basis of the bird's-eye-view features by means of a MAP head of the onboard map generation system; and

generating the map representation on the basis of the map features by means of a map prediction module of the onboard map generation system.

As a result, a technical advantage can be achieved that a precise generation of a map representation by means of the onboard map generation system on the basis of the image data and/or video data of the environmental sensors is made possible.

According to one example embodiment, the method further comprises:

generating feature vectors on the basis of the behavioral information of the map data by means of a map encoder of the onboard map generation system; and

fusing the feature vectors with the environmental sensor data.

As a result, a technical advantage can be achieved that, by generating the feature vectors on the basis of the behavioral information of the electronic road map, a precise fusion of the corresponding behavioral information with the environmental sensor data is made possible.

By fusing the correspondingly converted behavioral information with the environmental sensor data, an improved integration of the behavioral information into the map representation generated on the basis of the environmental sensor data is made possible.

The fusion of the corresponding feature vectors with the environmental sensor data can take place at different times during the processing of the environmental sensor data, provided by the environmental sensors, by means of the onboard map generation system.

In this case, the fusion of the feature vectors with the environmental sensor data is not intended to be limited to the pure environmental sensor data as provided by the environmental sensors. A fusion can also take place with the BEV features of the environmental sensor data or at an even later processing time.

According to one example embodiment, the fusion of the feature vectors with the environmental sensor data takes place in the map head, and/or wherein the fusion is effected via a cross-attention mechanism between the feature vectors and the BEV features of the environmental sensor data, and/or wherein the fusion of the feature vectors with the environmental sensor data takes place in the transformer of the BEV backbone, and/or wherein the feature vectors are fused via a cross-attention mechanism with the BEV features generated by the BEV backbone.

As a result, a technical advantage can be achieved that, by fusing the feature vectors with the environmental sensor data in the map head, a fusion of the feature vectors with the environmental sensor data that takes place as late as possible in the processing chain of the environmental sensor data is made possible. As a result, it can be achieved that previous processing steps of the environmental sensor data remain unaffected by the fusion with the feature vectors of the behavioral information.

By running the cross-attention mechanism to fuse the feature vectors with the BEV features of the environmental sensor data, a precise fusion can be achieved. By fusing the feature vectors with the environmental sensor data within a transformer of a BEV backbone in order to convert the environmental sensor data into the BEV features, it can be achieved that the feature vectors can be directly integrated into the BEV features to be generated on the basis of the environmental sensor data.

According to one example embodiment, generating the feature vectors comprises:

generating a sub-feature vector for each of the sub-information items of the behavioral information; and merging the sub-feature vectors to form a total feature vector by means of the map encoder.

This can achieve a technical advantage that, by generating the sub-feature vectors for each sub-information item of the behavioral information and by subsequently concatenating the plurality of sub-feature vectors into common feature vectors, a representation of the behavioral information of the road map in vector form that is as precise as possible is made possible.

According to one example embodiment, the map encoder comprises a plurality of artificial sub-networks, wherein each sub-network is configured to generate a corresponding sub-feature vector on the basis of the map data for a sub-information item of the behavioral information.

As a result, a technical advantage can be achieved that precise sub-feature vectors can be generated on the basis of the different sub-information items of the behavioral information by means of the artificial sub-networks and generative neural networks of the map encoder. By virtue of the correspondingly trained artificial intelligences, each sub-information item of the behavioral information of the electronic road map can be taken into account individually.

According to one example embodiment, the average movement path and the average movement speed profile are each in the form of line information, wherein the average braking point and the average lane change point are each in the form of point information, and wherein generating the sub-feature vectors comprises:

representing the line information as a plurality of point information items and generating the sub-feature vectors as multidimensional vectors, wherein the dimension of a sub-feature vector corresponds to a sum of a number of point information items and a number of features of the particular sub-information item, and wherein the sub-information item of the average movement speed profile comprises the features from the following list: average speed, speed variance, median speed, first and third quartiles of the speed.

This can achieve a technical advantage that a precise representation of the behavioral information in the form of feature vectors is made possible.

According to one aspect of the present disclosure, a computing unit is provided that is configured to carry out the method according to one of the above-described embodiments for generating a map representation for a vehicle.

According to one aspect of the present disclosure, a computer program product is provided comprising commands that, when the program is executed by a data processing unit, cause the data processing unit to carry out the method according to one of the above-described embodiments for generating a map representation for a vehicle.

Example embodiments of the present disclosure are described with reference to the figures.

### BRIEF DESCRIPTION OF THE DRAWINGS

FIG. 1 is a graphical representation of an onboard map generation system for generating a map representation for a vehicle according to one example embodiment.

FIG. 2 is a graphical representation of map information for the onboard map generation system for generating the map representation according to a further example embodiment.

FIG. 3 is a schematic representation of a map encoder of the onboard map generation system according to one example embodiment.

FIG. 4 is a flowchart of a method for generating a map representation for a vehicle according to a further example embodiment,

FIG. 5 is a further flowchart of the method for generating a map representation for a vehicle according to a further example embodiment.

FIG. 6 is a schematic representation of a computer program product, according to an example embodiment.

### DETAILED DESCRIPTION OF EXAMPLE EMBODIMENTS

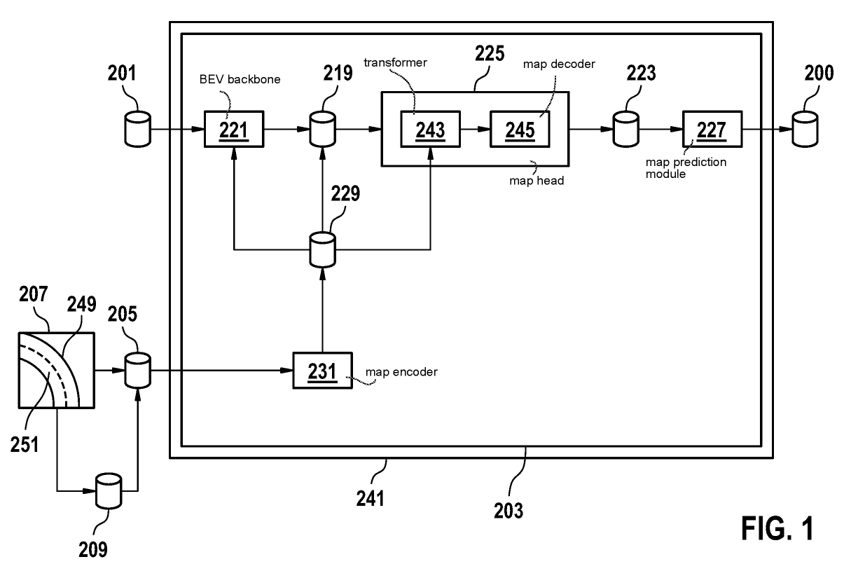

FIG. 1 is a graphical representation of an onboard map generation system 203 for generating a map representation 200 for a vehicle according to one embodiment.

According to the present disclosure, the onboard map generation system 203 is configured to generate a map representation 200 of the environment of the vehicle on the basis of environmental sensor data 201 of at least one environmental sensor of the vehicle and map data 205 of an electronic road map 207.

The map data 205 comprise at least behavioral information 209 of the electronic road map 207. The behavioral information 209 is taken into account in the onboard map generation of the map representation 200, so that the map representation 200, after generation, comprises the behavioral information 209 of the electronic road map 207.

The electronic road map 207 is based on historical data, which are based, for example, on historical trips by a plurality of different vehicles and on the environmental sensor data of the respective vehicles recorded during the trips. The electronic road map 207 thus represents a depiction of a traffic infrastructure. According to the present disclosure, the electronic road map 207 comprises the aforementioned behavioral information 209.

The behavioral information 209 comprises information regarding the average behavior of other road users in road traffic.

According to one embodiment, the behavioral information 209 comprises at least one sub-information item from the following list: average movement path 211, average movement speed profile 213, average braking point 215, average lane change point 217.

In this case, movement paths 211 are movement trajectories of the movements of the road users. Movement speed profiles 213 represent position-related speed information of the movements of the road users. Braking points 215 represent position-related information regarding speed reductions. Lane change points 217 represent position-related information regarding changing the traveled lane of a particular road.

According to one embodiment, the environmental sensor data 201 comprise image data and/or video data.

In the embodiment shown, the onboard map generation system 203 comprises a BEV backbone 221. The BEV backbone 221 is configured to convert the environmental sensor data 201 into BEV features 219, i.e., into bird's-eye-view features.

In the embodiment shown, the onboard map generation system 203 further comprises a map head 225 having a transformer 243 and a map decoder 245. In this case, the map head 225 is configured to generate map features 223 on the basis of the BEV features 219 of the environmental sensor data 201.

In the embodiment shown, the onboard map generation system 203 further comprises a map prediction module 227. In this case, the map prediction module 227 is configured to generate the map representation 200 on the basis of the map features 223.

In the embodiment shown, the onboard map generation system 203 further comprises a map encoder 231. In this case, the map encoder 231 is configured to generate feature vectors 229 on the basis of the map data 205 of the electronic road map 207 and the comprised behavioral information 209. In this case, the feature vectors 229 are in the form of multidimensional vectors and comprise the information of the map data 205, in particular the behavioral information 209.

In order to integrate the behavioral information 209 of the electronic road map 207, the onboard map generation system 203 is configured to fuse the feature vectors 229 with the environmental sensor data 201.

In this case, the electronic road map 207 serves as a map prior, as is conventional for onboard map generation systems.

FIG. 1 shows three different fusion alternatives A, B, C.

In fusion variant A, the feature vectors 229 representing the behavioral information 209 are fused with the environmental sensor data 201 within the BEV backbone 221.

The fusion of the environmental sensor data 201 with the feature vectors 229 within the BEV backbone 221 can take place analogously to Luo et al. (K. Z. Luo, X. Weng, Y. Wang, S. Wu, J. Li, K. Q. Weinberger, Y. Wang, and M. Pavone, "Augmenting lane perception and topology understanding with standard definition navigation maps," in 2024 IEEE International Conference on Robotics and Automation (ICRA), pp. 4029–4035, IEEE, 2024).

In fusion variant B, the feature vectors 229 are directly fused with the BEV features 219 of the environmental sensor data 201.

The fusion of the feature vectors 229 with the BEV features 219 can take place analogously to Wu et al. (H. Wu, Z. Zhang, S. Lin, T. Qin, J. Pan, Q. Zhao, C. Xu, and M. Yang, "Blos-bev: Navigation map enhanced lane segmentation network, beyond line of sight," in 2024 IEEE Intelligent Vehicles Symposium (IV), pp. 3212–3219, IEEE, 2024).

In fusion variant C, the fusion of the feature vectors 229 with the environmental sensor data 201 takes place within the transformer 243 of the map head 225. The fusion of the feature vectors 229 with the environmental sensor data 201 within the transformer 243 of the map head 225 can take place by means of a cross-attention mechanism.

According to one embodiment, the transformation of the environmental sensor data 201 into the BEV features 219 by means of the BEV backbone 221 takes place analogously to Yang et al. (C. Yang, Y. Chen, H. Tian, C. Tao, X. Zhu, Z. Zhang, G. Huang, H. Li, Y. Qiao, L. Lu, et al., "Bevformer v2: Adapting modern image backbones to bird’s-eye-view recognition via perspective supervision," in Proceedings of the IEEE/CVF Conference on Computer Vision and Pattern Recognition, pp. 17830–17839, 2023).

In FIG. 1, the onboard map generation system 203 is shown to be executable on a computing unit 241.

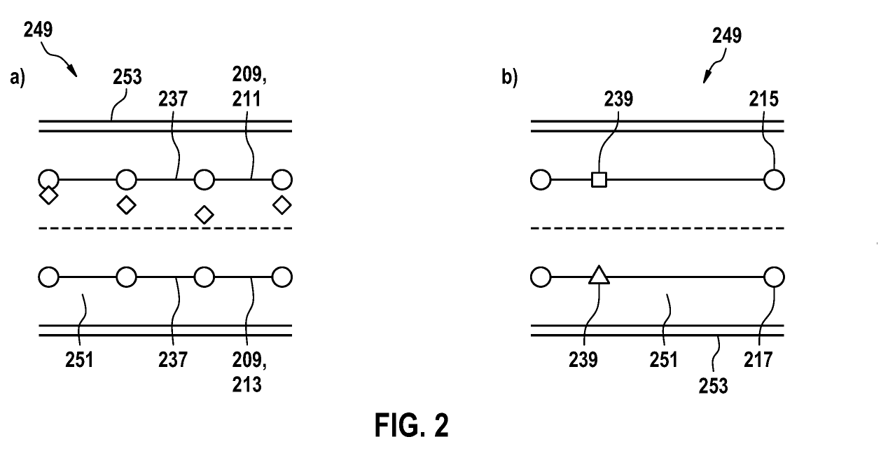

FIG. 2 shows graphical representations of map information for the onboard map generation system 203 for generating the map representation 200 according to a further embodiment.

In graphic a), an average movement path 211 and an average movement speed profile 213 are represented as possible sub-information items of the behavioral information 209. The average movement path 211 and the average movement speed profile 213 are each represented as line information 237 in graphic a).

The average movement path 211 here represents a graphical course of an average movement along the road 249.

The average movement speed profile 213 represents a graphical representation of an average movement speed along the road 249.

The represented sub-information items of the behavioral information 209 are each based on historical data from multiple passes of a plurality of vehicles along the road 249.

Graphic b) shows, as two further sub-information items of the behavioral information 209, an average braking point 215 and an average lane change point 217.

In this case, the average braking point 215 represents positional information at which the road users typically carry out a braking maneuver when moving along the road 249.

The average lane change point 217 accordingly represents positional information at which the road user on average carries out a lane change between different lanes 251 of the road 249.

The average braking point 215 and the average lane change point 217 are each represented as point information 239.

To generate the feature vectors 229 on the basis of the sub-information items of the behavioral information 209 which are represented as line information 237, such as the average movement path 211 and the average movement speed profile 213, the line information 237 is sampled according to a sampling mechanism and parametrized in the form of a plurality of point information items 239.

To generate the feature vectors 229, a line of uniform length is converted for each line information item 237 into a predefined number of point information items 239.

By converting the line information 237 for each feature vector 229 into a uniform number of point information items 239, it is possible to provide the respective sub-feature vectors, which represent the particular sub-information item of the behavioral information 209, with a uniform dimension.

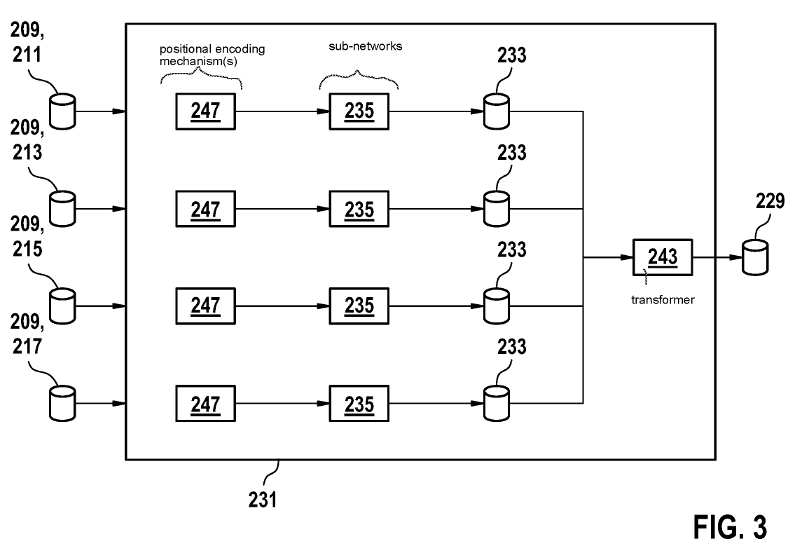

FIG. 3 is a schematic representation of a map encoder 231 of the onboard map generation system 203 according to one embodiment.

In the embodiment shown, the map encoder 231 comprises four sub-networks 235, each of which is in the form of a multilayer perceptron MLP. The sub-networks 235 serve to generate individual sub-feature vectors 233 for the individual sub-information items of the behavioral information 209.

For this purpose, the sub-information items, in the examples shown the four different sub-information items, of the behavioral information 209 in the form of the average movement path 211, the average movement speed profile 213, the average braking point 215 and the average lane change point 217 are provided to the map decoder 231 as input data.

The individual sub-information items are first preprocessed by means of a positional encoding mechanism 247 and then provided to the respective sub-networks 235.

Said sub-networks create a corresponding sub-feature vector 233 for each sub-information item.

The four sub-feature vectors 233 are subsequently concatenated and provided to a transformer 243 of the map encoder 231.

The transformer 243 subsequently provides a summary behavioral vector 229, which comprises the four sub-information items of the behavioral information 209.

For each line information item 237, for example the average movement path 211 or the average movement speed profile 213, a fixed number nₗᵢₙₑₛ of point information items 239 are first created for lines of uniform length.

Next, a sub-feature vector 233 of dimension nₗᵢₙₑₛₓ (kₚₒₛ + k_{feature}) is generated, where kₚₒₛ is the feature dimension of the positional encoding 247 and k_{feature} is the feature dimension of the input feature, i.e., the average movement path 211 or the average movement speed profile 213.

In the case of the average movement speed profile 213, k_{feature} is equal to 5, where the dimension of 5 is obtained from the average speed, the speed variance, the median speed, and the first and third quartiles of the speed.

For the average movement path 211, k_{feature} is equal to 1 and corresponds to the variance at the particular location.

By executing the particular sub-network 235 and carrying out a corresponding reshaping operation, the sub-feature vector 233 of dimension k is ascertained.

For the point information 239, the average braking point 215 and the average lane change point 217, the input vector for the sub-network 235 has the dimension kₚₒₛ + k_{feature}. In this case, k_{feature} is equal to 1, i.e., the frequency of the particular average braking point 215 or lane change point 217.

By executing the particular sub-network 235 on the correspondingly generated input vectors, the particular sub-feature vector 233 with the dimension k is then generated.

Subsequently, the sub-feature vectors 233 are concatenated n_{behavior} x k, where n_{behavior} represents the number of sub-information items of the behavioral information 209.

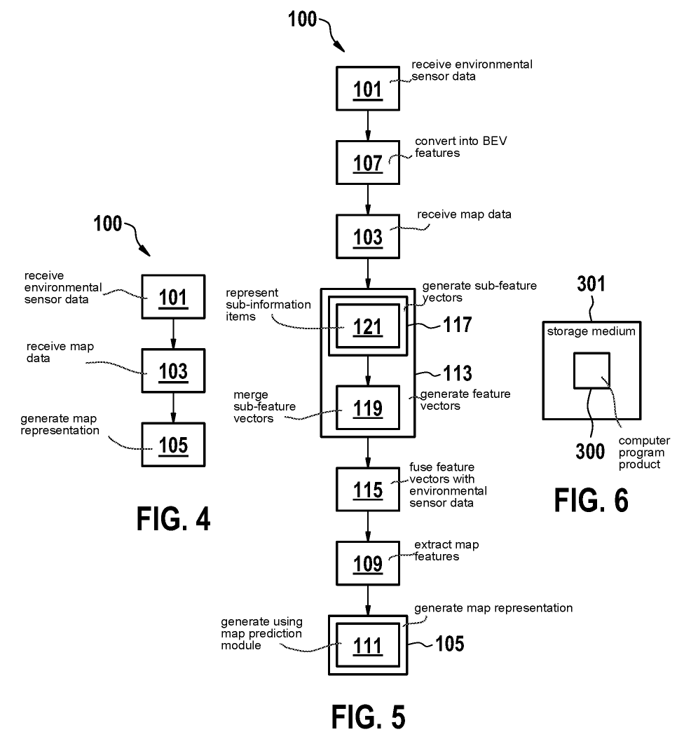

FIG. 4 is a flowchart of a method 100 for generating a map representation 200 for a vehicle according to a further embodiment.

To generate a map representation 200 for a vehicle, environmental sensor data 201 of the at least one environmental sensor of the vehicle are first received by means of the onboard map generation system 203 in a method step 101. In this case, the environmental sensor data 201 at least partially depict the environment of the vehicle.

In a further method step 103, map data 205 of an electronic road map 207 are received by means of the onboard map generation system 203.

The electronic road map 207 serves as a map prior and depicts the traffic infrastructure within the environment of the vehicle. The map data 205 comprise at least behavioral information 209.

In a further method step 105, the map representation 200 is generated by means of the onboard map generation system 203 on the basis of the environmental sensor data 201 and the behavioral information 209 of the map data 205 of the electronic road map 207.

In this case, the map representation 200 comprises the behavioral information 209. Here, the map representation 200 is generated as an onboard map generation and is carried out during operation of the vehicle.

FIG. 5 is a further flowchart of the method 100 for generating a map representation 200 for a vehicle according to a further embodiment.

The embodiment shown is based on the embodiment in FIG. 4 and comprises all the method steps described there.

In the embodiment shown, in a method step 107, the received environmental sensor data 201 are converted into bird's-eye-view features 219 by means of a transformer 243 of the BEV backbone 221 of the onboard map generation system 203.

In a further method step 113, the feature vectors 229 are generated by means of the map encoder 231 of the onboard map generation system 203 on the basis of the behavioral information 209 of the map data 205 of the electronic road map 207.

For this purpose, in a method step 117, a sub-feature vector 233 is generated for each of the sub-information items of the behavioral information 209.

To this end, in a method step 121, the sub-information items of the behavioral information 209 which are represented as line information 237 are each represented as a plurality of point information items 239 and the sub-feature vectors 233 are generated as multidimensional vectors, wherein the dimension of a sub-feature vector 233 corresponds to a sum of the number of point information items 239 and a number of features of the particular sub-information item.

In a further method step 119, the sub-feature vectors 233 are merged to form a total feature vector 229 by means of the map encoder 231.

In a further method step 115, the feature vectors 229 are fused with the environmental sensor data 201.

In a further method step 109, map features 223 are extracted on the basis of the bird's-eye-view features 219 by means of a map head 225 of the onboard map generation system 203.

In a further method step 111, the map representation 200 is generated on the basis of the map features 223 by means of a map prediction module 227 of the onboard map generation system 203.

FIG. 6 is a schematic representation of a computer program product 300 comprising commands that, when the program is executed by a data processing unit, cause the data processing unit to carry out the method 100 for generating a map representation 200 for a vehicle.

In the embodiment shown, the computer program product 300 is stored on a storage medium 301. Here, the storage medium 301 can be any storage medium from the related and prior art.

What is claimed is:

1. A computer-implemented method for generating a map representation for a vehicle, the method comprising the following steps:
receiving, using an onboard map generation system, environmental sensor data of at least one environmental sensor of the vehicle, wherein the environmental sensor data at least partially depict an environment of the vehicle;
receiving map data of an electronic road map using the onboard map generation system, wherein the map data at least partially depict a traffic infrastructure within the environment of the vehicle, and wherein the map data include behavioral information regarding average behavior of other road users in relation to the traffic infrastructure; and
generating, using the onboard map generation system, the map representation of the environment of the vehicle based on the environmental sensor data and the behavioral information of the map data, wherein the map representation includes the behavioral information.

2. The method according to claim 1, wherein the behavioral information includes at least one sub-information item from the following list: average movement path, average movement speed profile, average braking point, average lane change point.

3. The method according to claim 1, wherein the environmental sensor data include image data and/or video data.

4. The method according to claim 1, further comprising:
converting the environmental sensor data into bird's-eye-view (BEV) features using a transformer of a BEV backbone of the onboard map generation system;
extracting map features based on the BEV features using a map head of the onboard map generation system; and
generating the map representation based on the map features using a map prediction module of the onboard map generation system.

5. The method according to claim 4, further comprising:
generating feature vectors based on the behavioral information of the map data using a map encoder of the onboard map generation system; and
fusing the feature vectors with the environmental sensor data.

6. The method according to claim 5, wherein the fusion of the feature vectors with the environmental sensor data is performed by at least one of:
(i) the map head,
(ii) a cross-attention mechanism between the feature vectors and the BEV features of the environmental sensor data, or
(iii) the transformer of the BEV backbone.

7. The method according to claim 5, wherein the feature vectors are fused via a cross-attention mechanism with the BEV features generated by the BEV backbone.

8. The method according to claim 5, wherein the behavioral information includes at least one sub-information item from the following list: average movement path, average movement speed profile, average braking point, average lane change point, and wherein the generating of the feature vectors includes:
generating a sub-feature vector for each respective sub-information item of the sub-information items of the behavioral information; and
merging the sub-feature vectors to form a total feature vector using the map encoder.

9. The method according to claim 8, wherein the map encoder includes a plurality of artificial sub-networks, wherein each sub-network of the plurality of artificial sub-networks is configured to generate a corresponding sub-feature vector based on the map data for a sub-information item of the behavioral information.

10. The method according to claim 8, wherein the average movement path and the average movement speed profile are each in the form of line information, wherein the average braking point and the average lane change point are each in the form of point information, and wherein the generating of the sub-feature vectors includes:
representing the line information as a plurality of point information items and generating the sub-feature vectors as multidimensional vectors, wherein a dimension of each sub-feature vector corresponds to a sum of a number of point information items and a number of features of the respective sub-information item, and wherein the sub-information item of the average movement speed profile includes at least one feature from the following list: average speed, speed variance, median speed, first quartile of speed, and third quartile of the speed.

11. A computing unit configured to generate a map representation for a vehicle, the computing unit configured to perform a method comprising the following steps:
receiving, using an onboard map generation system, environmental sensor data of at least one environmental sensor of the vehicle, wherein the environmental sensor data at least partially depict an environment of the vehicle;
receiving map data of an electronic road map using the onboard map generation system, wherein the map data at least partially depict a traffic infrastructure within the environment of the vehicle, and wherein the map data include behavioral information regarding average behavior of other road users in relation to the traffic infrastructure; and
generating, using the onboard map generation system, the map representation of the environment of the vehicle based on the environmental sensor data, and the behavioral information of the map data, wherein the map representation includes the behavioral information.

12. A non-transitory computer-readable storage medium on which is stored a computer program product including commands for generating a map representation for a vehicle, the commands, when executed by a data processor, causing the data processor to perform the following steps:
receiving, using an onboard map generation system, environmental sensor data of at least one environmental sensor of the vehicle, wherein the environmental sensor data at least partially depict an environment of the vehicle;
receiving map data of an electronic road map using the onboard map generation system, wherein the map data at least partially depict a traffic infrastructure within the environment of the vehicle, and wherein the map data include behavioral information regarding average behavior of other road users in relation to the traffic infrastructure; and
generating, using the onboard map generation system, the map representation of the environment of the vehicle based on the environmental sensor data, and the behavioral information of the map data, wherein the map representation includes the behavioral information.
